(19) United States
(12) Patent Application Publication
(10) Pub. No.: US 2014/0315019 A1
(43) Pub. Date: Oct. 23, 2014

(54) ADHESIVE FILM HAVING A PHASE DIFFERENCE, METHOD FOR MANUFACTURING SAME, AND OPTICAL MEMBER INCLUDING SAME

(71) Applicants: Ik Hwan Cho, Uiwang-si (KR); In Cheon Han, Uiwang-si (KR)

(72) Inventors: Ik Hwan Cho, Uiwang-si (KR); In Cheon Han, Uiwang-si (KR)

(21) Appl. No.: 14/343,812

(22) PCT Filed: Jul. 3, 2012
(86) PCT No.: PCT/KR2012/005259

§ 371 Date: Mar. 7, 2014

(30) Foreign Application Priority Data
Aug. 9, 2011 (KR) 10-2011-0091374

(51) Int. Cl. C09D 133/14; B29C 55/00; G02B 5/30

(52) U.S. Cl. CPC C09D 133/14; G02B 5/3025; B29C 55/005
USPC 428/354; 428/355 R; 525/281; 522/117; 264/232; 264/494

(57) ABSTRACT

According to the present invention, an adhesive film having a phase-difference is characterized by a phase difference value of 25° C./55% RH at a thickness of 20 μm being approximately 20 nm to approximately 150 nm, and 1 rad/s storage modulus by a frequency seep test at 30° C. being approximately 10⁵ dyne/cm² to approximately 10⁹ dyne/cm². The adhesive film having a phase-difference exhibits minimal entangling and retains a stretched structure under high temperature and humidity so as to provide an optical member that has decreased light leakage, retains superior durability, reworkability, and adhesion, and has an excellent balance of physical properties.

### TECHNICAL FIELD

The present invention relates to a phase-difference adhesive film, a method for manufacturing the same, and an optical member including the same. More particularly, the present invention relates to an adhesive film that can minimize entanglement to maintain a stretched structure even under high temperature and high humidity conditions, thereby providing a phase difference while ensuring excellent properties in terms of durability, reworkability and adhesion, and can provide an optical member having excellent property balance, a method for manufacturing the same, and an optical member including the same.

### BACKGROUND ART

Examples of optical films may include polarizing plates, color filters, retardation films, elliptical polarizing films, reflective films, anti-reflective films, compensation films, brightness-enhancing films, alignment films, light diffusion films, glass anti-scattering films, surface protective films, plastic LCD substrates, and the like, which can be applied to various optical members including liquid crystal displays.

Among these optical films, a polarizing plate includes iodine compounds or dichroic polarizing materials arranged in a certain direction and has a multilayer structure, which includes protective films, such as triacetyl cellulose (TAC) films, on both sides thereof to protect polarizing elements. In addition, the polarizing plate may further include optical viewing angle compensation films, such as a retardation film having unidirectional molecular arrangement, a liquid crystal type film, and the like. Since these films are produced from materials having different molecular structures and compositions, these films exhibit different physical properties. Particularly, under high temperature/high humidity conditions, these films exhibit insufficient dimensional stability due to shrinkage or expansion of materials having unidirectional molecular arrangement. Thus, when the polarizing plate is secured to a certain member via an adhesive, stress is concentrated on a TAC layer upon shrinkage or expansion of the polarizing plate under high temperature/high humidity conditions, causing birefringence and light leakage. This phenomenon is referred to as light leakage and is generally known to occur upon conversion of optical isotropy of a stretched polarizing film into anisotropy due to shrinkage of the film under high temperature/high humidity conditions. Moreover, even in the case that a phase retardation function is imparted to an adhesive, shrinkage/expansion of the polarizing plate changes phase characteristic of the adhesive under high temperature/high humidity conditions.

Accordingly, it is necessary for an adhesive for polarizing films to have excellent durability under high temperature and high humidity conditions while maintaining a phase difference.

Conventionally, an adhesive layer does not have a phase difference in order to prevent deterioration in display visibility. In recent years, however, a phase-difference adhesive film has been developed by imparting a phase difference to the adhesive film to provide not only functions as adhesives but also an optical compensation function.

Here, when imparted to a typical adhesive film in the art, the phase difference is generally imparted to an optical compensation type film in a direction of minimizing a phase difference due to stress. Further, in preparation of a phase difference adhesive layer in the art, an adhesive film is subjected to stretching in a non-crosslinked state, followed by thermal crosslinking. In this case, since adhesives generally have a glass transition temperature Tg of 0° C. or less, stretching of the film in a non-crosslinked state causes the film to return to an original state, causing stretched polymer chains to entangle. As a result, a stretched state is released under high temperature conditions and thus the degree of shrinkage increases, thereby causing not only increase in light leakage of the polarizing plate, but also variation in phase difference to provide adverse influence on properties of the polarizing plate.

### DISCLOSURE

### Technical Problem

It is an aspect of the present invention to provide a phase-difference adhesive film, which can minimize entanglement to maintain a stretched structure under high temperature and high humidity conditions, thereby ensuring excellent durability while suppressing light leakage, and a method for manufacturing the same.

It is another aspect of the present invention to provide a phase-difference adhesive film exhibiting both phase difference and adhesion, and a method for manufacturing the same.

It is a further aspect of the present invention to provide a phase-difference adhesive film, which can be stretched without attaching a release film, thereby maintaining stable properties, and a method for manufacturing the same.

It is yet another aspect of the present invention to provide an optical member exhibiting excellent property balance using the phase-difference adhesive film.

### Technical Solution

One aspect of the present invention relates to a phase-difference adhesive film. The phase-difference adhesive film has a phase difference of about 20 nm to about 150 nm at a thickness of 20 μm at 25° C. and 55% RH, and a storage modulus of about 1×10⁵ dyne/cm² to about 1×10⁹ dyne/cm² upon frequency sweep testing under conditions of 30° C. and 1 rad/s.

The phase-difference adhesive film may have a phase difference of about 30 nm to about 150 run.

In one embodiment, the phase-difference adhesive film may have a gel fraction of about 90% or higher as represented by the following Equation 1:

Gel fraction (%)=(A/B)×100,

where A is the mass of a remaining material after dissolving in ethyl acetate at room temperature (23° C.) for 72 hours, followed by drying at 150° C. for 1 hour, and B is an initial mass of the adhesive film.

The phase-difference adhesive film may include a (meth)acrylate copolymer, a polyfunctional (meth)acrylate, and a curing agent. In some embodiments, the phase-difference adhesive film may further include a photoinitiator, a thermal initiator, or combinations thereof.

The (meth)acrylate copolymer may contain a hydroxyl group, a carboxyl group, or combinations thereof.

The (meth)acrylate copolymer may have a weight average molecular weight of about 1,000,000 g/mol to about 5,000,000 g/mol.

Another aspect of the present invention relates to a method for manufacturing a phase-difference adhesive film. The method includes: forming an adhesive film by crosslinking an adhesive composition including a (meth)acrylate copolymer, a polyfunctional (meth)acrylate and a curing agent; stretching the adhesive film; and curing the stretched adhesive film.

In one embodiment, stretching may be performed in a machine direction MD such that the adhesive film is stretched to a length of about 2 times to about 5 times an initial length thereof.

In one embodiment, stretching may be performed with respect to the adhesive film alone without attaching a release film.

In one embodiment, the stretched adhesive film may be subjected to UV curing.

A further aspect of the present invention relates to an optical member including the phase-difference adhesive film.

The optical member may include an optical film; and a phase-difference adhesive film attached to one or both sides of the optical film.

In one embodiment, the optical film may be a polarizing film.

### Advantageous Effects

The present invention provides a phase-difference adhesive film that can minimize entanglement to maintain a stretched structure even under high temperature and high humidity conditions so as to ensure excellent durability while suppressing light leakage, and can be stretched without attaching a release film, thereby maintaining stable properties. The present invention also provides a method for manufacturing the same, and an optical member exhibiting excellent property balance using the phase-difference adhesive film.

### DESCRIPTION OF DRAWINGS

FIG. 1 is a sectional view of an optical member in accordance with one embodiment of the present invention.

### BEST MODE

Hereinafter, embodiments of the invention will be described in detail. It should be understood that the following embodiments are provided for illustration only and the scope of the present invention is defined only by the claims and equivalents thereof.

Unless otherwise stated, the term “(meth)acrylate” means both acrylate and methacrylate. Further, “(meth)acrylic acid” means both acrylic acid and methacrylic acid. “(Meth)acryl amide” means both “acryl amide” and “methacryl amide”.

A phase-difference adhesive film according to the present invention is prepared by forming an adhesive film by crosslinking an adhesive composition including a (meth)acrylate copolymer, a polyfunctional (meth)acrylate and a curing agent; stretching the adhesive film; and curing the stretched adhesive film. In other words, according to the present invention, the adhesive composition is subjected to stretching after crosslinking in order to maintain a stretched structure even under high temperature/high humidity conditions by minimizing entanglement, instead of stretching in a non-crosslinked state as in the related art.

Next, components of the adhesive composition will be described.

(Meth)acrylate Copolymer

The (meth)acrylate copolymer is prepared through polymerization of a monomer mixture including a C₁ to C₂₀ alkyl (meth)acrylate and a monomer copolymerizable therewith.

Examples of the C₁ to C₂₀ alkyl (meth)acrylate may include methyl (meth)acrylate, ethyl (meth)acrylate, propyl (meth)acrylate, butyl (meth)acrylate, pentyl (meth)acrylate, hexyl (meth)acrylate, heptyl (meth)acrylate, octyl (meth)acrylate, nonyl (meth)acrylate, decyl (meth)acrylate, dodecyl (meth)acrylate, and lauryl (meth)acrylate, without being limited thereto. These may be used alone or in combination thereof. Here, the term “(meth)acrylate” means both acrylate and methacrylate.

The copolymerizable monomer may include a hydroxyl group-containing monomer, a carboxyl group-containing monomer, a monomer having positive birefringence, and the like.

In one embodiment, the (meth)acrylate copolymer may include about 60 wt % to about 99 wt % of the C₁ to C₂₀ alkyl (meth)acrylate, about 0.01 wt % to about 20 wt % of the hydroxyl group-containing monomer, about 0 wt % to about 10 wt % of the carboxyl group-containing monomer, and about 0 wt % to about 10 wt % of the monomer having positive birefringence.

In another embodiment, the (meth)acrylate copolymer may include about 60 wt % to about 99 wt % of the C₁ to C₂₀ alkyl (meth)acrylate, about 0 wt % to about 20 wt % of the hydroxyl group-containing monomer, about 0.01 wt % to about 10 wt % of the carboxyl group-containing monomer, and about 0 wt % to about 10 wt % of the monomer having positive birefringence.

Examples of the hydroxyl group-containing monomer may include 2-hydroxyethyl (meth)acrylate, 4-hydroxybutyl (meth)acrylate, 2-hydroxypropyl (meth)acrylate, 2-hydroxybutyl (meth)acrylate, 6-hydroxyhexyl (meth)acrylate, 1,4-cyclohexanedimethanol mono(meth)acrylate, chloro-2-hydroxypropyl acrylate, diethylene glycol mono(meth)acrylate, and aryl alcohol, without being limited thereto. Preferably, the hydroxyl group-containing monomer is a hydroxyl group-containing C₁ to C₁₀ alkyl (meth)acrylate. These may be used alone or in combination thereof.

Examples of the carboxyl group-containing monomer may include (meth)acrylic acid, 2-carboxyethyl (meth)acrylate, 3-carboxypropyl (meth)acrylate, 4-carboxybutyl (meth)acrylate, itaconic acid, crotonic acid, maleic acid, fumaric acid, and maleic anhydride, without being limited thereto. These may be used alone or in combination thereof.

The monomer having positive birefringence may include an aromatic (meth)acrylate. Examples of the monomer having positive birefringence may include methacrylic acid, such as cyclohexyl (meth)acrylate, 2-ethylphenoxy (meth)acrylate, 2-ethylthiophenyl (meth)acrylate, phenyl (meth)acrylate, benzyl (meth)acrylate, 2-phenylethyl (meth)acrylate, 3-phenylpropyl (meth)acrylate, 4-phenylbutyl (meth)acrylate, 2-2-methylphenylethyl (meth)acrylate, 2-3-methylphenylethyl (meth)acrylate, 2-4-methylphenylethyl (meth)acrylate, 2-(4-propylphenypethyl (meth)acrylate, 2-(4-(1-methylethyl)phenyl)ethyl (meth)acrylate, 2-(4-methoxyphenyl)ethyl (meth)acrylate, 2-(4-cyclohexyl phenyl)ethyl (meth)acrylate, 2-(2-chlorophenyl)ethyl (meth)acrylate, 2-(3-chlorophenyl)ethyl (meth)acrylate, 2-(4-chlorophenyl)ethyl (meth)acrylate, 2-(4-bromophenyl)ethyl (meth)acrylate, 2-(3-phenylphenyl)ethyl (meth)acrylate, and 2-(4-benzylphenyl)ethyl (meth)acrylate, without being limited thereto. These may be used alone or as mixtures thereof.

The (meth)acrylate copolymer may have a weight average molecular weight of about 1,000,000 g/mol to about 5,000,000 g/mol. Preferably, the (meth)acrylate copolymer has a weight average molecular weight of about 1,000,000 to about 2,000,000 g/mol. Within this range, the (meth)acrylate copolymer provides excellent properties to the adhesive composition in terms of elongation and durability.

The (meth)acrylate copolymer may have a glass transition temperature (Tg) from about −30° C. to about 20° C., preferably from about −20° C. to about 10° C. Within this range of glass transition temperature, the (meth)acrylate copolymer provides excellent adhesion and durability to the adhesive composition.

Polyfunctional (meth)Acrylate

As the polyfunctional (meth)acrylate, bi- or higher functional (meth)acrylates containing two or more (meth)acryl groups may be used. For example, the polyfunctional (meth)acrylate may include bi-functional acrylates, such as 1,4-butanediol di(meth)acrylate, 1,6-hexanediol di(meth)acrylate, neopentylglycol di(meth)acrylate, polyethylene glycol di(meth)acrylate, neopentylglycol adipate di(meth)acrylate, hydroxyl puivalic acid neopentylglycol di(meth)acrylate, dicyclopentanyl di(meth)acrylate, caprolactone-modified dicyclopentenyl di(meth)acrylate, ethylene oxide-modified di(meth)acrylate, di(meth)acryloxy ethyl isocyanurate, allylated cyclohexyl di(meth)acrylate, tricyclodecane dimethanol (meth)acrylate, dimethylol dicyclopentane di(meth)acrylate, ethylene oxide-modified hexahydrophthalic acid di(meth)acrylate, tricyclodecane dimethanol (meth)acrylate, neopentylglycol-modified trimethylpropane di(meth)acrylate, adamantane di(meth)acrylate, 9,9-bis[4-(2-actyloyloxyethoxy)phenyl]fluorine, and the like; tri-functional acrylates, such as trimethylolpropane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, tri-functional urethane (meth)acrylate, tris(meth)acryloxyethyl isocyanurate, and the like; tetra-functional acrylates, such as diglycerin tetra(meth)acrylate, pentaerythritol tetra(meth)acrylate, and the like; penta-functional acrylates, such as propionic acid-modified dipentaerythritol penta(meth)acrylate, and the like; and dipentaerythritol hexa(meth)acrylate, caprolactone-modified dipentaerythritol hexa(meth)acrylate, urethane (meth)acrylate, and the like, without being limited thereto. These may be used alone or in combination thereof.

The polyfunctional (meth)acrylate may be present in an amount of about 0.1 parts by weight to about 30 parts by weight, preferably about 1 part by weight to about 25 parts by weight, more preferably about 5 parts by weight to about 20 parts by weight, based on 100 parts by weight of the (meth)acrylate copolymer. Within this content range, the polyfunctional (meth)acrylate provides high storage modulus and excellent durability to the adhesive composition. In one embodiment, the polyfunctional (meth)acrylate may be present in an amount of about 10, 11, 12, 13, 14, 15, 16, 17, 18, 19, 20, 21, 22, 23, 24, or 25 parts by weight based on 100 parts by weight of the (meth)acrylate copolymer.

Curing Agent

Examples of the curing agent may include isocyanate, epoxy, aziridine, melamine, amine, imide, carbodiimide, amide curing agents, and combinations thereof.

Examples of the isocyanate curing agent may include toluene diisocyanate, xylene diisocyanate, diphenylmethane diisocyanate, hexamethylene diisocyanate, isoform diisocyanate, tetramethyl xylene diisocyanate, naphthalene diisocyanate, and polyols thereof (trimethylol propane and the like), without being limited thereto. These may be used alone or in combination thereof.

Examples of the epoxy curing agent may include ethylene glycol diglycidyl ether, triglycidyl ether, trimethylol propane triglycidyl ether, N,N,N′N′-tetraglycidylethylene diamine, and glycerine diglycidyl ether, without being limited thereto. These may be used alone or in combination thereof.

The imide curing agent may be carbodiimide.

These curing agents may be used alone or in combination thereof. The curing agent may be present in an amount of about 0.01 parts by weight to about 2 parts by weight, preferably about 0.05 parts by weight to about 1 part by weight, more preferably about 0.1 parts by weight to about 0.5 parts by weight, based on 100 parts by weight of the (meth)acrylate copolymer. Within this content range, the curing agent can provide excellent properties in terms of durability, adhesion reliability and reworkability to the adhesive film.

The adhesive composition may further include a photoinitiator, a thermal initiator, or combinations thereof.

The photoinitiator is activated by UV or electron beams to promote radical reaction through activation of carbon-carbon double bonds in the adhesive film. Examples of the photoinitiator may include α-hydroxy ketone type compounds, benzyl ketal type compounds, and mixtures thereof, without being limited thereto. Preferably, α-hydroxy ketone compounds such as 1-hydroxy-cyclohexyl-phenyl-ketone, 2-hydroxy-2-methyl -1-phenyl-1-propanone, 2-hydroxy-1-[4-(2-hydroxyethoxy)phenyl]-2-methyl-1-propanone and the like may be used. These initiators may be used alone or in combination thereof. The photoinitiator may be present in an amount of about 0.1 parts by weight to about 5 parts by weight, preferably about 1 part by weight to about 3 parts by weight, based on 100 parts by weight of the (meth)acrylate copolymer. Within this content range, the photoinitiator provides low light leakage and excellent durability to the adhesive composition.

As the thermal initiator, a typical initiator such as azo-based compounds, peroxide compounds or redox compounds may be used, without being limited thereto. The thermal initiator may be present in an amount of about 0.1 parts by weight to about 5 parts by weight, preferably about 1 part by weight to about 3 parts by weight, based on 100 parts by weight of the (meth)acrylate copolymer. Within this content range, the thermal initiator provides excellent durability to the adhesive composition.

According to the present invention, the adhesive composition may further include a silane coupling agent to improve adhesion stability and reliability.

Examples of the silane coupling agent may include γ-glycidoxypropyltrimethoxysilane, γ-glycidoxypropylmethyldiethoxysilane, γ-glycidoxypropyltriethoxysilane, 3-mercaptopropyltrimethoxysilane, vinyltrimethoxysilane, vinyltriethoxysilane, γ-methacryloxypropyltrimethoxysilane, γ-methacryloxypropyltriethoxysilane, γ-aminopropyltriethoxysilane, 3-isocyanatepropyltriethoxysilane, γ-acetoacetatepropyl trimethoxysilane, and the like. These may be used alone or in combination thereof.

The silane coupling agent may be present in an amount of about 0.01 parts by weight to about 3 parts by weight, preferably about 0.05 parts by weight to about 2 parts by weight, more preferably about 0.1 parts by weight to about 1.5 parts by weight, based on 100 parts by weight of the (meth)acrylate copolymer. Within this content range, the silane coupling agent can provide excellent adhesion stability and reliability to the adhesive composition.

The adhesive composition may optionally further include typical additives, such as curing accelerators, ionic liquids, lithium salts, inorganic fillers, softening agents, antioxidants, anti-aging agents, stabilizers, tackifier resins, modifying resins (such as polyol, phenol, acrylic, polyester, polyolefin, epoxy, epoxidized polybutadiene resins, and the like), leveling agents, antifoaming agents, plasticizers, dyes, pigments (such as coloring pigments, extender pigments, and the like), treatment agents, UV protective agents, fluorescence brightening agents, dispersants, heat stabilizers, light stabilizers, UV absorbents, antistatic agents, lubricants, and solvents, as needed.

The adhesive composition comprising these components is coated onto a release film, followed by drying and crosslinking, thereby forming an adhesive film. Crosslinking is performed at about 30° C. to about 70° C. for about 1 to 30 hours. Coating is performed to form a layer having a thickness of about 10 μm to about 100 μm, preferably about 20 μm to about 70 μm.

The cross-linked adhesive film is aligned by stretching. Stretching may be performed using a stretching machine at about 30° C. to about 50° C. at a stretching rate of about 1 m/min to about 3 m/min in a machine direction (MD).

In one embodiment, stretching may be performed in the machine direction such that the adhesive film has a length of about 2 to 5 times an initial length of the adhesive film. Within this range, the adhesive film has high reproducibility and can realize stable properties.

According to the present invention, since the adhesive film is stretched in a completely cross-linked state, the adhesive film may be stretched alone without attaching a release film thereto. As a result, the adhesive film can be stretched alone as compared with on-film stretching causing variation in phase difference of an adhesive layer by the release film, thereby securing stable properties.

As described above, the stretched adhesive film is subjected to curing. In some embodiments, curing may be UV curing at room temperature.

The phase-difference adhesive film produced by the method as described above may have a phase difference of about 20 nm to about 150 nm, preferably about 30 nm to about 150 nm, for example, about 50 nm to about 150 nm, more preferably about 100 nm to about 150 nm at a thickness of 20 μm at 25° C. and 55% RH. Within this range, the phase-difference adhesive can replace conventional films.

Further, the phase-difference adhesive film may have a storage modulus of about 1×10⁵ to about 1×10⁹ dyne/cm², preferably about 10⁶ to about 10⁸ dyne/cm², upon frequency sweep testing under conditions of 30° C. and 1 rad/s. Within this range, the phase-difference adhesive film can minimize variation of phase difference under high temperature and high humidity conditions.

In one embodiment, the phase-difference adhesive film may have a gel fraction of about 90% or more, preferably about 95% to about 99%, as represented by the following Equation 1. Within this range, the phase-difference adhesive film can minimize entanglement to maintain a stretched structure and can minimize variation of phase difference under high temperature and high humidity conditions.

Gel fraction (%)=(A/B)×100, [Equation 1]

wherein A is the mass of a remaining material after dissolving in ethyl acetate at room temperature (23° C.) for 72 hours, followed by drying at 150° C. for 1 hour, and B is an initial mass of the adhesive film.

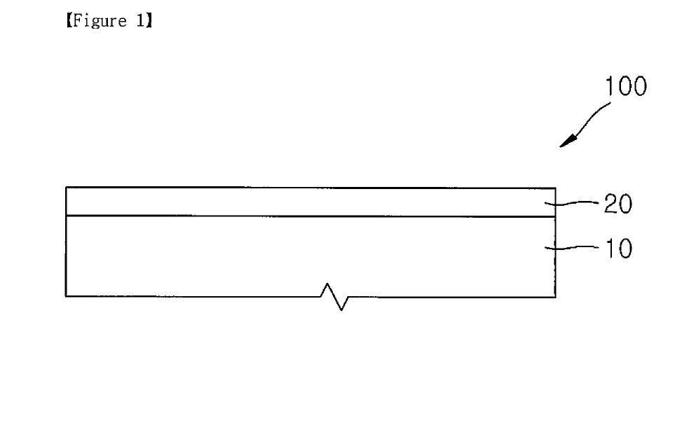

A further aspect of the present invention relates to an optical member including the phase-difference adhesive film. FIG. 1 is a sectional view of an optical member in accordance with one embodiment of the present invention. As shown, an optical member 100 includes an optical film 10 and an adhesive film 20 stacked on the optical film. In some embodiments, the optical member may include an optical film; and a phase-difference adhesive film(s) stacked on one or both sides of the optical film. In one embodiment, the optical film 10 may be a polarizing film.

The adhesive film 20 may have a thickness of about 10 μm to about 100 μm, preferably about 20 μm to about 70 μm.

Examples of the optical film may include polarizing plates, color filters, retardation films, elliptical polarizing films, reflective films, anti-reflective films, compensation films, brightness-enhancing films, alignment films, light diffusion films, glass anti-scattering films, surface protective films, plastic LCD substrates, and the like. In this invention, the optical film may be applied to a polarizing film. In addition, the optical film may be easily manufactured by a person having ordinary knowledge in the art.

Next, the present invention will be described with reference to some examples. It should be understood that the following examples are provided for illustration only and are not to be construed in any way as limiting the present invention.

### MODE FOR INVENTION

### Example

### Example 1

0.5 parts by weight of an isocyanate curing agent (XDI-adduct type) and 0.005 parts by weight of a curing accelerant (DBTDL) were added to 100 parts by weight of a solvent type (meth)acrylate copolymer having a weight average molecular weight of 1,300,000 g/mol and consisting of BA/OH (95/5), followed by adding 1.5 parts by weight of a photoinitiator (Irgacure 184) and 20 parts by weight of a polyfunctional (meth)acrylate (tris(acryloxy ethyl) isocyanurate, M315, Donga Synthesis Company), thereby preparing an adhesive composition. The adhesive composition was coated onto a release film to a thickness of 60 μm, followed by drying and crosslinking (50° C., 24 hr) to prepare an adhesive film. Next, the adhesive film was stretched at 1 m/min to have a length of 3 times an initial length thereof. After stretching, the adhesive film was subjected to UV irradiation, thereby preparing a phase-difference adhesive film.

### Example 2

A phase-difference adhesive film was prepared in the same manner as in Example 1 except that the content of the polyfunctional (meth)acrylate was changed as in Table 1.

### Example 3

A phase-difference adhesive film was prepared in the same manner as in Example 1 except that a (meth)acrylate copolymer having a weight average molecular weight of 1,000,000 g/mol was used.

### Example 4

A phase-difference adhesive film was prepared in the same manner as in Example 1 except that a solvent type (meth)acrylate copolymer having a weight average molecular weight of 1,000,000 g/mol and consisting of AA/BA (5/95) and an epoxy curing agent (743L) were used.

### Comparative Example 1

A phase-difference adhesive film was prepared in the same manner as in Example 1 except that a polyfunctional (meth)acrylate and a photoinitiator were not used and photo-curing was not performed after stretching.

### Comparative Example 2

A phase-difference adhesive film was prepared in the same manner as in Comparative Example 1 except that the content of the curing agent was changed.

Comparative Example 3

A phase-difference adhesive film was prepared in the same manner as in Example 4 except that a polyfunctional (meth)acrylate and a photoinitiator were not used and photo-curing was not performed after stretching.

### Comparative Example 4

A phase-difference adhesive film was prepared in the same manner as in Example 1 except that a polyfunctional (meth)acrylate was not used.

### Comparative Example 5

A phase-difference adhesive film was prepared in the same manner as in Example 1 except that stretching was not performed.

In the following Table 1, the content of each component is given in parts by weight in terms of solid content.

TABLE 1

| | | | | | Comparative | Comparative | Comparative | Comparative | Comparative |
|---|---|---|---|---|---|---|---|---|---|
| | Example 1 | Example 2 | Example 3 | Example 4 | Example 1 | Example 2 | Example 3 | Example 4 | Example 5 |
| Acrylate | 100 | 100 | 100 | 100 | 100 | 100 | 100 | 100 | 100 |
| copolymer | | | | | | | | | |
| Poly- | 15 | 20 | 15 | 15 | — | — | — | — | 15 |
| functional | | | | | | | | | |
| acrylate | | | | | | | | | |
| Curing | (Isocyanate- | (Isocyanate- | (Isocyanate- | (Epoxy- | (Isocyanate- | (Isocyanate- | (Epoxy- | (Isocyanate- | (Isocyanate- |
| agent | based) | based) | based) | based) | based) 0.5 | based) 3.5 | based) 0.5 | based) 0.5 | based) 0.5 |
| | 0.5 | 0.5 | 0.5 | 0.5 | | | | | |
| Photo- | 1.5 | 1.5 | 1.5 | 1.5 | — | — | — | 1.5 | 1.5 |
| initiator | | | | | | | | | |
| Storage | 3 * 10⁷ | 3 * 10⁷ | 3 * 10⁷ | 3 * 10⁷ | 6 * 10⁵ | 8 * 10⁵ | 5 * 10⁶ | 5 * 10⁶ | 5 * 10⁶ |
| modulus | | | | | | | | | |
| Phase | 35 nm ± 5 | 40 nm ± 5 | 35 nm ± 5 | 35 nm ± 5 | less than 3 nm | less than 3 nm | less than 3 nm | less than 3 nm | less than 3 nm |
| difference | | | | | | | | | |
| Gel | 98% or | 98% or | 98% or | 98% or | 55% | 70% | 60% | 60% | 98% or |
| fraction | more | more | more | more | | | | | more |
| (%) | | | | | | | | | |
| Durability | ◯ | ◯ | ◯ | ◯ | Δ | Δ | Δ | Δ | ◯ |

### Property Evaluation

1. Storage modulus (dyne/cm²): A specimen having a diameter of 8 mm and a thickness of 1 mm was prepared by stacking an adhesive layer, and storage modulus was measured using a rheometer (1 rad/s) through frequency sweep testing at 30° C.

2. Phase difference (nm): Phase difference was measured on a 20 μm thick specimen using a phase difference tester (Axo Scan) under conditions of 25° C./55% RH.

3. Gel fraction: An adhesive film was dipped in an ethyl acetate solution at room temperature (23° C.) for 72 hours and weight change of the adhesive film was measured. Gel fraction was calculated by the following Equation 1:

Gel fraction (%)=(A/B)×100,

wherein A is the mass of a remaining material after dissolving in ethyl acetate at room temperature (23° C.) for 72 hours, followed by drying at 150° C. for 1 hour, and B is an initial mass of the adhesive film.

4. Durability: Polarizing plates (90 mm×170 mm) were attached to both sides of a glass substrate (110 mm×190 mm×0.7 mm) such that optical absorption axes thereof crossed each other. Here, a force of about 5 kg/cm² was applied thereto and pressing was performed in a clean room so as to prevent generation of bubbles and introduction of foreign matter. To evaluate moisture/heat resistance, specimens were left under conditions of 60° C. and 90% RH for 1000 hours, followed by observation of bubbling or delamination. For evaluation of heat resistance, the specimens were left under conditions of 80° C. for 1000 hours, followed by observation of bubbling or delamination with the naked eye. The specimens were left at room temperature for 24 hours immediately before evaluation of the specimens. Evaluation standards were as follows.

∘: Excellent (No bubbling or delamination)

Δ: Good (Slight bubbling or delamination)

x: Poor (Severe bubbling or delamination)

As can be seen from Table 1, the adhesive films prepared in Examples 1 to 4 had a high phase difference and excellent durability, whereas the adhesive films prepared in Comparative Examples 1 to 4 had deteriorated durability.

It should be understood that various modifications, changes, alterations, and equivalent embodiments can be made by those skilled in the art without departing from the spirit and scope of the invention.

1. A phase-difference adhesive film having a phase difference of about 20 nm to about 150 nm at a thickness of 20 μm at 25° C. and 55% RH, and a storage modulus of about 1×10⁵ dyne/cm² to about 1×10⁹dyne/cm² upon frequency sweep testing under conditions of 30° C. and 1 rad/s.

2. The phase-difference adhesive film according to claim 1, wherein the phase-difference adhesive film has a phase difference of about 30 nm to about 150 nm.

3. The phase-difference adhesive film according to claim 1, wherein the phase-difference adhesive film has a gel fraction of about 90% or higher as represented by the following Equation 1:
Gel fraction (%)=(A/B)×100,
where A is the mass of a remaining material after dissolving in ethyl acetate at room temperature (23° C.) for 72 hours, followed by drying at 150° C. for 1 hour, and B is an initial mass of the adhesive film.

4. The phase-difference adhesive film according to claim 1, comprising: a (meth)acrylate copolymer; a polyfunctional (meth)acrylate; and a curing agent.

5. The phase-difference adhesive film according to claim 4, further comprising: a photoinitiator, a thermal initiator or combinations thereof.

6. The phase-difference adhesive film according to claim 4, wherein the (meth)acrylate copolymer has a hydroxyl group, a carboxyl group, or combinations thereof.

7. The phase-difference adhesive film according to claim 4, wherein the (meth)acrylate copolymer has a weight average molecular weight of about 1,000,000 g/mol to about 5,000,000 g/mol.

8. A method for manufacturing a phase-difference adhesive film, comprising:
forming an adhesive film by crosslinking an adhesive composition including a (meth)acrylate copolymer, a polyfunctional (meth)acrylate, and a curing agent;
stretching the adhesive film; and
curing the stretched adhesive film.

9. The method according to claim 8, wherein the stretching is performed in a machine direction (MD) such that the adhesive film is stretched to a length of about 2 times to about 5 times an initial length thereof.

10. The method according to claim 8, wherein the stretching is performed with respect to the adhesive film alone without attaching a release film.

11. The method according to claim 8, wherein the stretched adhesive film is subjected to UV curing.

12. An optical member comprising the phase-difference adhesive film according to claim 1.

13. The optical member according to claim 12, wherein the optical member comprises an optical film; and the phase-difference adhesive film attached to one or both sides of the optical film.

14. The optical member according to claim 12, wherein the optical film is a polarizing film.
